(19) United States
(12) Patent Application Publication
(10) Pub. No.: US 2008/0079284 A1
(43) Pub. Date: Apr. 3, 2008

(54) Door mechanism

(76) Inventor: Heriberto Moreno, Santa Ana, CA (US)

Correspondence Address: Rolando J. Tong, PO Box 802691, Valencia, CA, 91380, US

(21) Appl. No.: 11/729,591

(22) Filed: Mar. 29, 2007

Related U.S. Application Data
(60) Provisional application No. 60/848,188, filed on Sep. 29, 2006.

(51) Int. Cl. B60J 5/00

(52) U.S. Cl. 296/146.12; 296/146.4

(57) ABSTRACT

A door mechanism configured to open or close a door of a vehicle, the door mechanism comprising a cylindrical body attached to the door and a chamber attached to the vehicle, the chamber configured to hold the cylindrical body, the cylindrical body being configured to rotate and slide within the chamber, wherein when the cylindrical body slides and rotates within the chamber in a first direction, the door moves in a first direction, when the cylindrical body slides and rotates within the chamber in a second direction, the door moves in a second direction.

### CROSS REFERENCES TO RELATED APPLICATIONS

This application is related to and claims the benefit of priority from U.S. provisional application Ser. No. 60/848,188 filed Sep. 29, 2006, the entire contents of which are incorporated herein.

### FIELD OF INVENTION

The present invention relates to vehicle doors, particularly vehicle doors that open in a vertical manner.

### BACKGROUND

Vehicle doors that open upwards relative to the ground instead of the common sideways motion exist. Examples of these vehicle doors include those disclosed in U.S. design Pat. No. 150,161 issued to R. L. Jean-Baptiste Sanmori, U.S. Pat. No. 3,589,069 issued to Lecomte, U.S. Pat. No. 6,676,193 issued to Hanagan, and U.S. Pat. No. 7,048,322 issued to DeBono.

The present inventor has found a hinge mechanism that is not disclosed in the above references and that may be used for vehicle doors that open in the direction that is substantially perpendicular to the ground. The hinge mechanism involves easy-to-manufacture non-motorized mechanical parts that work effectively. The present invention may involve fewer mechanical parts than the vehicle doors disclosed in the above references. Thus, the hinge mechanism may require less maintenance and may involve fewer parts that may break.

### BRIEF DESCRIPTION OF EMBODIMENTS OF THE PRESENT INVENTION

The present invention includes a door mechanism configured to open or close a door of a vehicle, the door mechanism comprising a cylindrical body attached to the door and a chamber attached to the vehicle, the chamber configured to hold the cylindrical body, the cylindrical body being configured to rotate and slide within the chamber, wherein when the cylindrical body slides and rotates within the chamber in a first direction, the door moves in a first direction, when the cylindrical body slides and rotates within the chamber in a second direction, the door moves in a second direction.

The above description sets forth, rather broadly, a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective view of a vehicle having the door mechanism of the present invention.

FIG. 2 is substantially a front view of the vehicle door of the present invention in the open position.

FIG. 3 is substantially a front view of the latch for the door mechanism of the present invention.

FIG. 4 is substantially a perspective view of the striker bolt for the door mechanism of the present invention.

FIG. 5 is substantially a front view of the door mechanism of the present invention.

FIG. 6 is substantially an exploded view showing the door mount embodiment, cylindrical body embodiment, cylindrical chamber embodiment, and the vehicle mount embodiment of the door mechanism of the present invention.

FIG. 7 is substantially a top partial view of a cylindrical chamber receiver embodiment of the door mechanism of the present invention.

FIG. 8 is substantially a front elevational view of the cylindrical body embodiment positioned within the cylindrical chamber embodiment of the door mechanism of the present invention.

FIG. 9 is substantially a cross-sectional view of the portion identified in FIG. 8.

### DESCRIPTION OF THE PREFERRED EMBODIMENTS

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. Also, it is to be understood that the phraseology and terminology employed herein are for the purpose of description and should not be regarded as limiting.

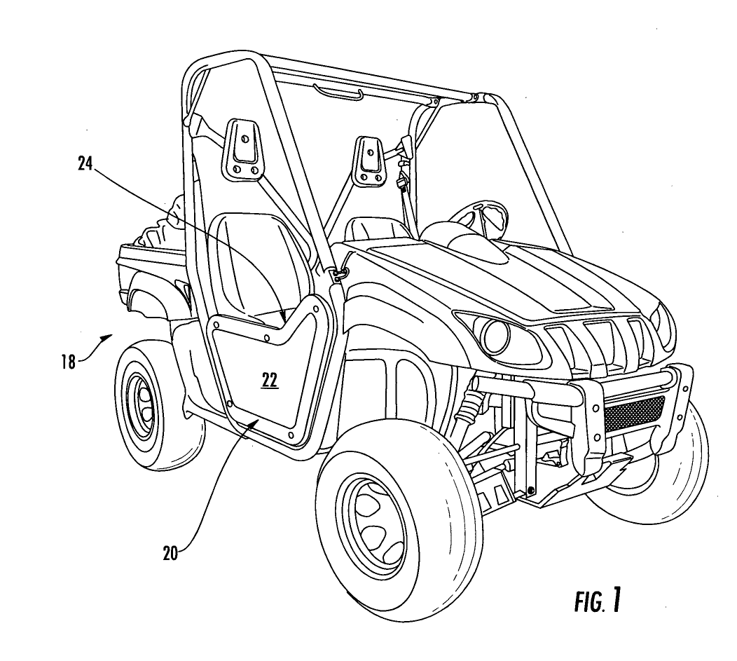

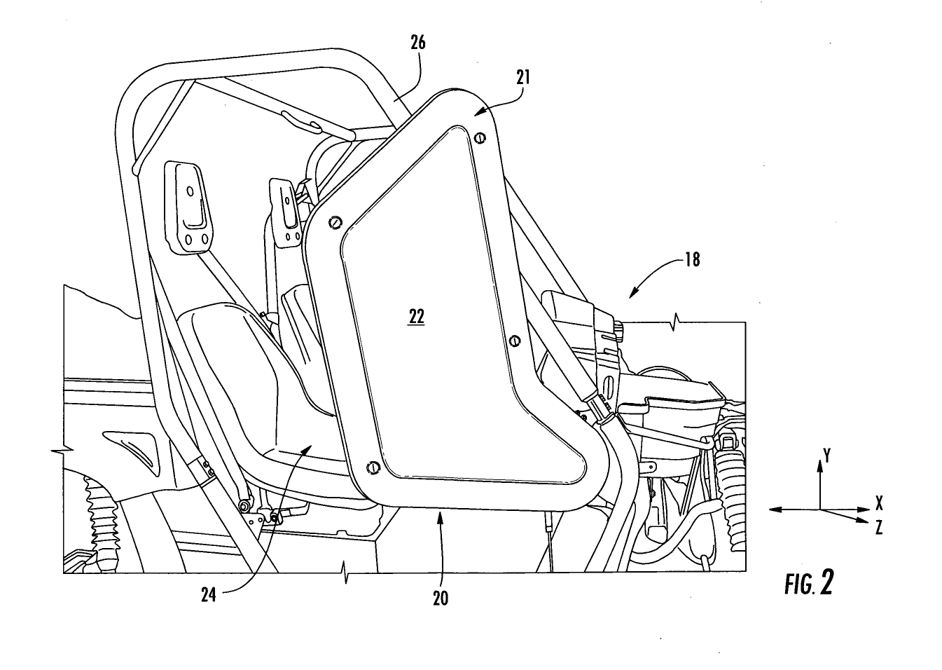

The present invention comprises a door mechanism, generally indicated by reference number 20. The door mechanism 20 is preferably for use with a vehicle 18, including all-terrain vehicles (ATVs), shown in FIG. 1. Door mechanism 20 preferably includes a door 22, which may be open or close an entrance 24 at least partially for a passenger or driver. FIG. 1 shows the door 22 in a closed position, wherein the door 22 at least partially blocks the entrance 24. FIG. 2 shows the door 22 in an open position, wherein a passenger or driver may enter the vehicle 18 through the entrance 24.

The door 22 preferably opens substantially upwards relative to the ground, or from the x-axis to the y-axis shown in FIG. 2. The door 22 preferably also opens slightly sideways to prevent the door 22 from hitting a portion of the vehicle's frame 26 when the door 22 opens upwards. This sideways movement is shown as the movement from the y-axis to the z-axis in FIG. 2. The sideways motion of the door allows a portion 21 of the door 22 to move up past the vehicle frame 26. It can be realized that by allowing the portion 21 of the door 22 to move up past the vehicle frame 26, the door 22 provides a wider entrance for the passenger or the driver than the entrance provided when the portion 21 of the door 22 stops moving past the vehicle frame 26.

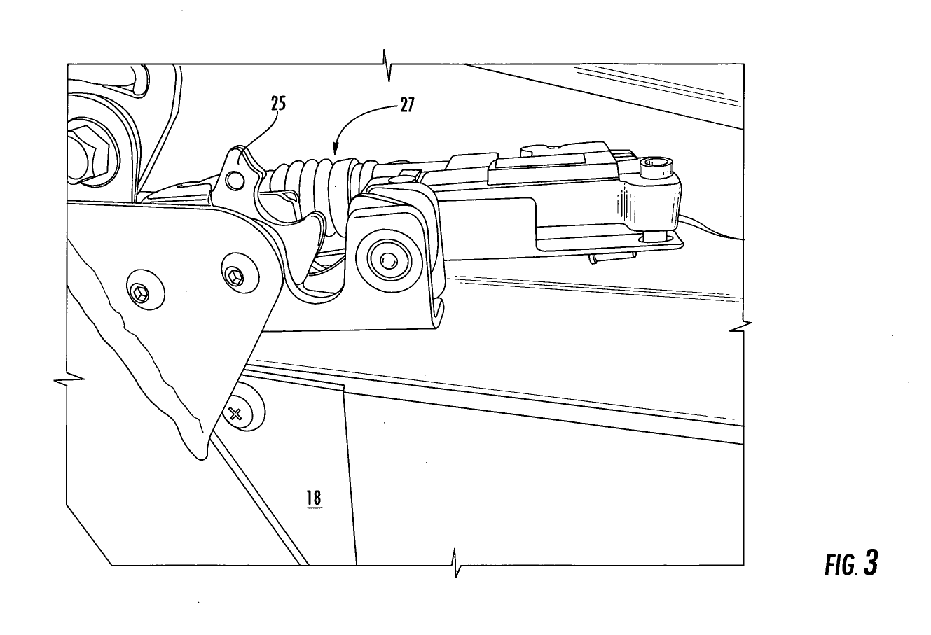

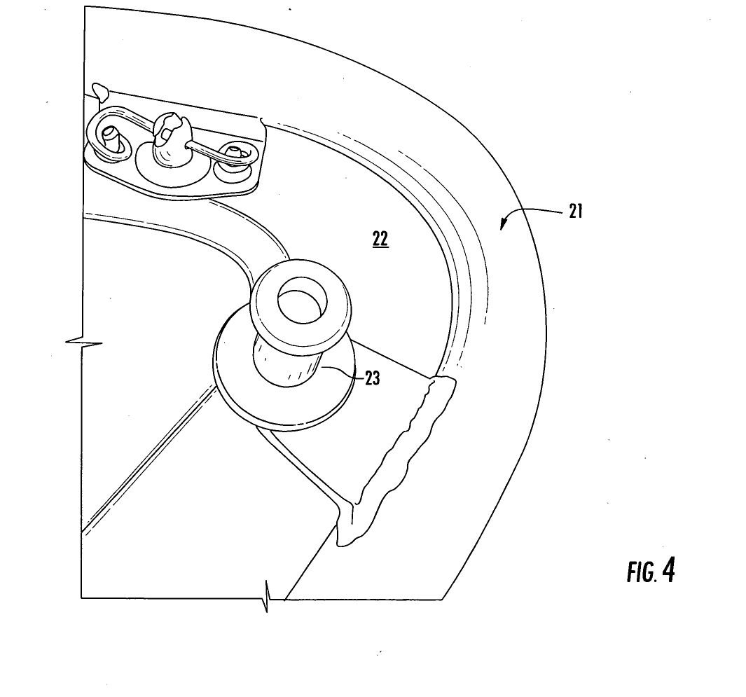

Referring now to FIGS. 3 and 4, the door mechanism 20 preferably includes a striker bolt 23 and a door latch 25 to engage the door 22 in the closed position. Striker bolt 23 is preferably attached to the door 22, and the door latch 25 is preferably attached to a portion of the vehicle 18. The door latch 25 is preferably configured to hold the striker bolt 23 when the door 22 is in the closed or locked position. The door latch 25 may release the striker bolt 23 to open the door. The door latch 25 may include a latch actuator 27 that may cause the door latch to hold or release the striker bolt 23. The latch actuator 27 may be actuated remotely for keyless entrance using an infrared remote control device known in the art. The striker bolt 23 and the latch 25 may be obtained from Rocky Hinge, Inc. of Girard, Ohio.

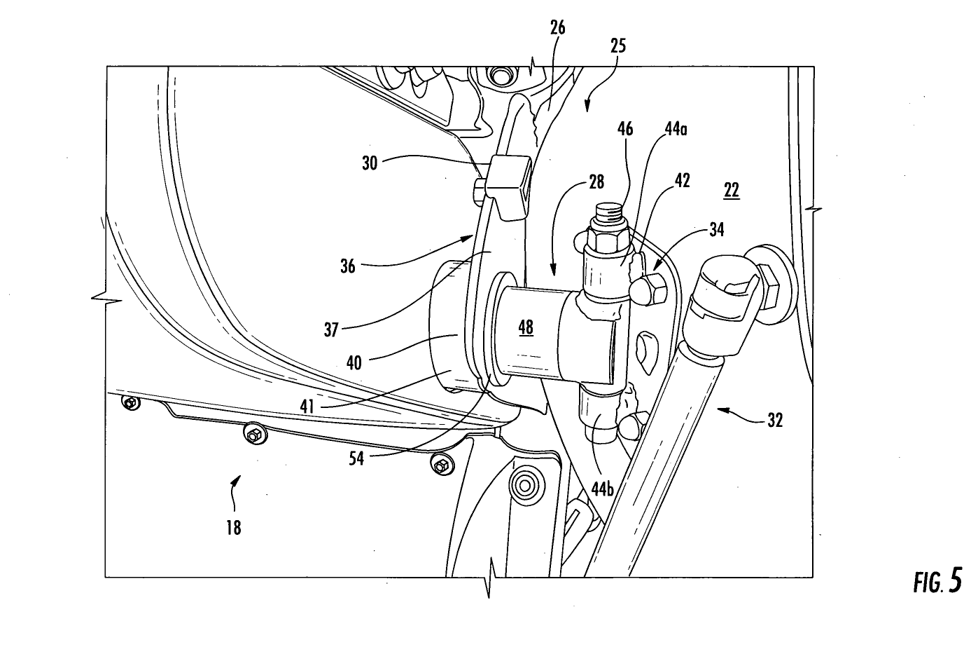

Referring now to FIG. 5, door mechanism 20 preferably includes a door 22, a hinge mechanism 28, a door guide 30, and a biasing mechanism 32. One end of the biasing mechanism 32 is preferably attached to the door 22, and another end of the biasing mechanism 32 is preferably attached to a portion of the vehicle 18, which is preferably positioned below the door when the door is in its closed position (not shown). The biasing mechanism 32 may be a gas actuated biasing device, such as those used as shock absorbers. Biasing mechanism 32 is preferably positioned and biased to cause the door to move vertically relative to the ground.

Hinge mechanism 28 preferably includes one end comprising a door mount 34 configured to be attached to the door 22 and another end comprising a vehicle mount 36 configured to be attached to a portion of the vehicle 18. In between the door mount 34 and the vehicle mount 36 is preferably a cylindrical body 48 configured to slide and rotate within a cylindrical chamber 54. The door mount 34 preferably includes a mounting plate 42, which may be mechanically fastened using mechanical fasteners or other known methods to the door 22. The mounting plate 42 preferably includes a pair of pin joints 44a and 44b where the cylindrical body 48 may be attached with a pin 46 to allow the door 22 to pivot around the cylindrical body 48.

Vehicle mount 36 is preferably a flat piece of material 37 welded to a vehicle chassis 38, but may be attached in various ways known in the art to any desired vehicle portion. A door guide 30 may be provided, which may be in the form of any material that would substantially protrude from the vertical axis defined by the vehicle frame 26. The door guide 30 is preferably configured to push the door 22 sideways when the door 22 comes in contact with it upon the door's upward motion. The vehicle mount 36 preferably includes a cylinder receiver 40, which may be a cylindrical piece 41 attached to the flat piece of material 37. The cylinder receiver 40 may be positioned within a cavity created from a vehicle's dashboard. The position of the cylinder receiver 40 may of course be varied, as desired.

It can be appreciated from FIG. 5 that when the door 22 is released from its closed position, the biasing mechanism 32 preferably raises the door 22 to a position that is substantially perpendicular from the ground while the cylindrical body 48 preferably rotates within the cylindrical chamber 54. Door guide 30 preferably causes the door 22 to move to the side when the door 22 comes in contact with it. A user may also move the door 22 to the side, as facilitated by sliding action of the cylindrical body 48 within the cylindrical chamber 54 and the pivot movement of the door around the pivot joints 44a and 44b of the door mount 34. As the door 22 moves to the side, the door 22 preferably continues its upward motion caused by the biasing mechanism 32 and the rotation of the cylindrical body 48 within the cylindrical chamber 54.

The upward movement of the door 22 preferably stops at the optimal open position wherein the biasing mechanism 32 has reached its maximum length and the cylindrical body 48 has reached its maximum rotation as dictated by its design and the cylindrical chamber's design, which are both described below. The optimal open position of the door 22 is shown in FIG. 2. It can be appreciated that at the optimal open position, a portion 21 of the door 22 is positioned forward from the vehicle frame 26. A user may further pivot the door 22 horizontally relative to the ground for a wider entrance to the vehicle.

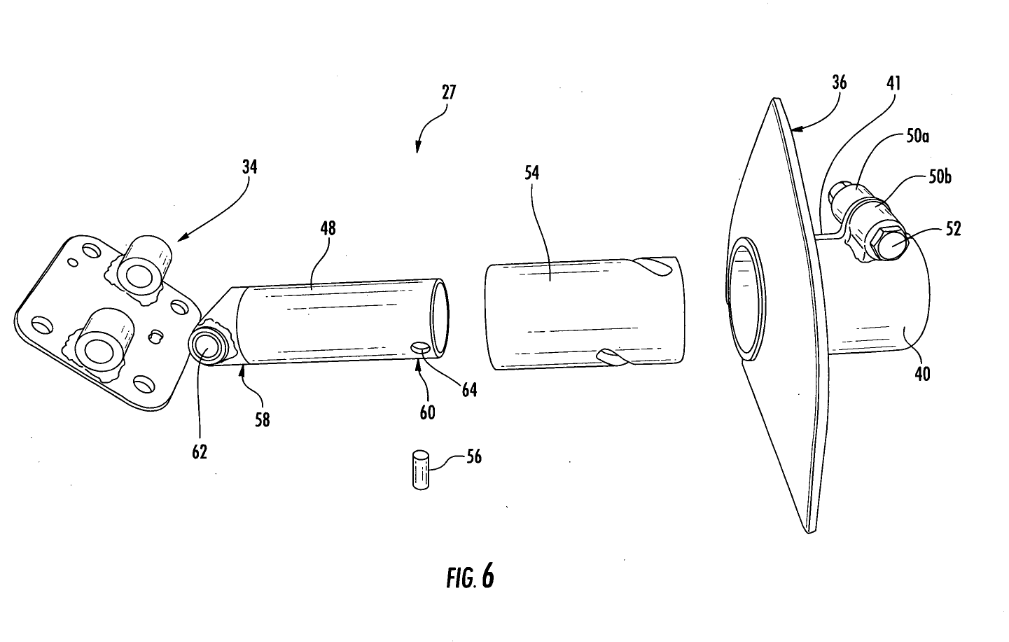

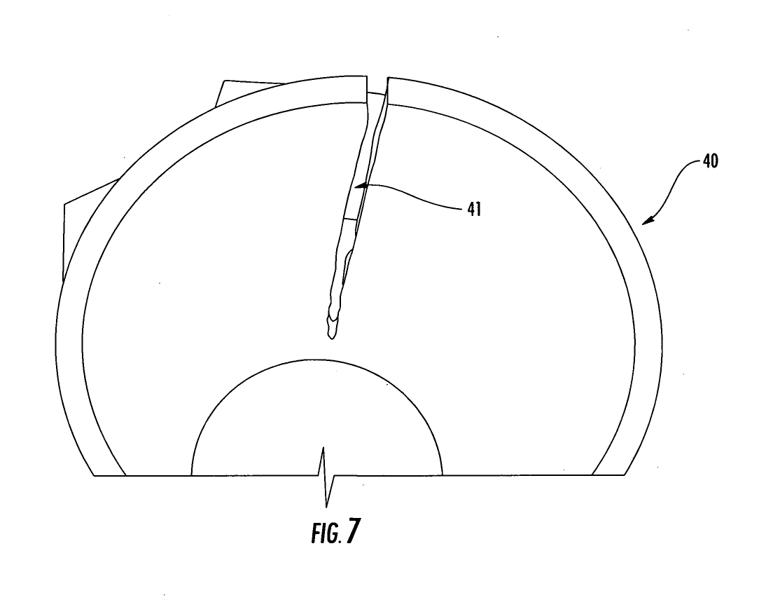

Referring now to FIG. 6, the cylinder receiver 40 preferably comprises a hollow cylinder that is open on both ends. The cylinder receiver 40 preferably includes a lateral opening 41 (shown in FIG. 7) running approximately three-fourths of the receiver's length. The lateral opening preferably allows the interior diameter of the cylinder receiver 40 to be adjusted. A pair of pin joints 50a and 50b are preferably attached to each side of the cylinder receiver 40 that is divided by the lateral opening. An adjustable pin 52 is preferably inserted within the pin joints 50a and 50b to allow a user to adjust the diameter of the cylinder receiver 40. The flexibility of the diameter of the cylinder receiver 40 provided by the lateral opening 41 allows the cylindrical chamber 54 to be positioned easily within the receiver 40 and to be tightened easily in place.

FIG. 6 shows the cylindrical body 48, which has one end 58 that is configured to be pivotably attached to the door mount 34 and another end 60 preferably configured to be inserted in the cylindrical chamber 54. End 58 preferably defines a pin passage 62 for a door mount pin 46. End 60 preferably defines a chamber pin passage 64 for a chamber pin 56, which may secure the cylindrical body 48 within the cylindrical chamber 54. Cylindrical body 48 and cylindrical chamber 54 are preferably made of different materials to allow long-term and continuous sliding and rotation of cylindrical body 48 within cylindrical chamber 54. For instance, cylindrical body 48 may be made of steel, and cylindrical chamber 54 may be made of aluminum.

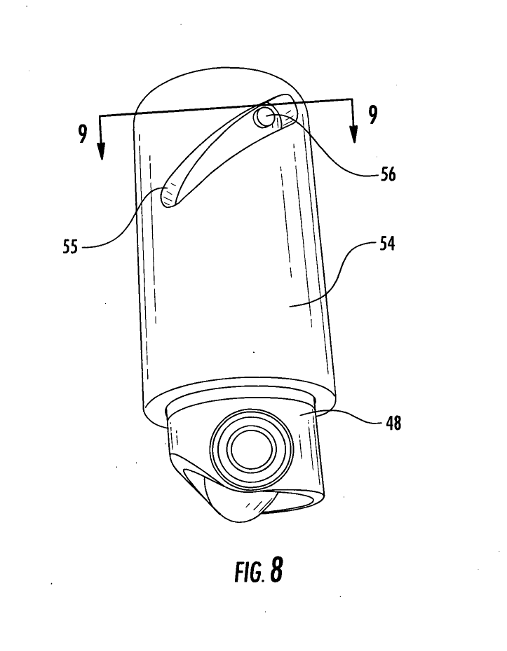

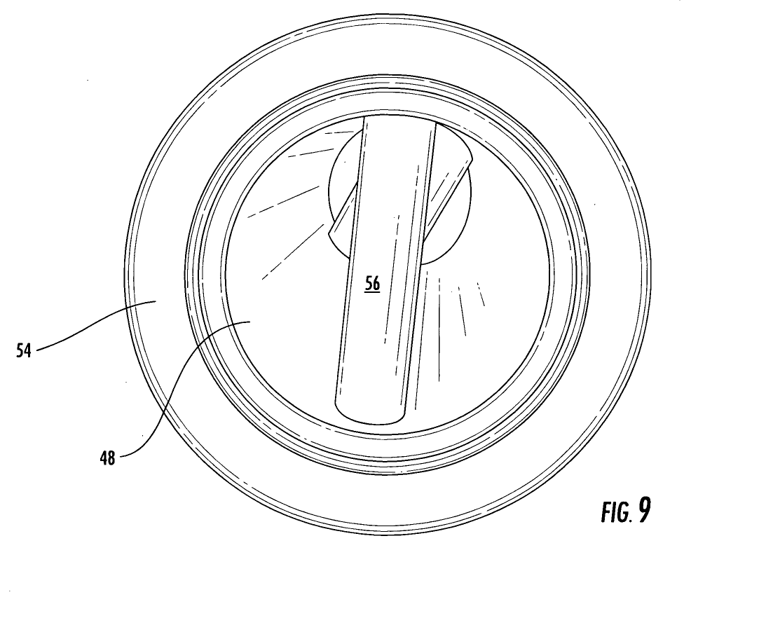

Referring now to FIG. 8, the cylinder chamber 54 may be designed such that it preferably defines a pair of substantially diagonal recess 55 opposite each other. The pair of substantially diagonal recess preferably crosses each other when both sides are overlaid onto each other (not shown). Referring to FIG. 9, cylindrical pin 56 preferably attaches the cylinder body 48 to the cylinder chamber 54. Cylindrical pin 56 preferably allows the cylinder body 48 to slide and rotate the cylinder chamber 54 in a controlled manner, as the cylindrical pin 56 travels within the pair of recess during the sliding and rotating motion of the cylinder body 48 within the cylinder chamber 54. It can be appreciated that the cylindrical pin 56 abuts the edge of the recess when the door 22 is in the optimal open position, and cylindrical pin 56 also abuts the opposite edge of the recess when the door 22 is in the closed position.

It can now be realized that the present invention provides a vehicle door that opens in a manner that is different from most conventional vehicle doors. The present invention also provides a hinge mechanism for a vehicle door that involves a small number of parts and is non-motorized. This means that the hinge mechanism may be easy to maintain, as there are not too many parts that may break. The present invention further provides a novel hinge mechanism that allows the vehicle door to open in a controlled manner.

Although the description above contains many specifications, these should not be construed as limiting the scope of the invention but as merely providing illustrations of some of presently preferred embodiments of this invention. For example, the positions of the vehicle mount and the door mount may be varied. The invention is capable of other embodiments and of being practiced and carried out in various ways. The invention is not limited in its application to the details of the construction and to the arrangement of the components set forth in the above description or as illustrated in the drawings.

What is claimed is:

1. A door mechanism for a door of a vehicle comprising:
(A) a biasing device attached to the door, the biasing device configured to allow the door to be raised and lowered;
(B) a cylindrical chamber attached to the vehicle, the cylindrical chamber defining a pair of elongate recess positioned opposite each other;
(C) a cylindrical body positioned to slide and rotate within the cylindrical chamber, the cylindrical body being secured by a pin within the cylindrical chamber, the pin being configured to move within the pair of elongate recess when the cylindrical body slides and rotates within the cylindrical chamber, the cylindrical body being attached to the door, wherein when the door is moved in a first direction, the cylindrical body rotates within the cylindrical chamber.

2. The door mechanism of claim 1 further comprising a pivot joint connecting the cylindrical body and the door, the pivot joint allowing the door to be moved in a direction substantially parallel to a ground.

3. The door mechanism of claim 1 wherein the pair of elongate recess are in a diagonal orientation.

4. The door mechanism of claim 1 further comprising a chamber mount configured to be attached to the vehicle and to mount the cylindrical chamber to the vehicle.

5. The door mechanism of claim 1 wherein the cylindrical body comprises a rotational axis, the door mechanism further comprising a door guide, the door guide being positioned off of the rotational axis, the door guide being configured to cause the door to move in a second direction.

6. The door mechanism of claim 1 further comprising a striker bolt attached to the door, a door latch attached to the vehicle, and a latch actuator attached to the door latch, wherein the latch actuator may be activated wirelessly.

7. A door mechanism configured to open or close a door of a vehicle, the door mechanism comprising:
(A) a cylindrical body attached to the door;
(B) a chamber attached to the vehicle, the chamber configured to hold the cylindrical body, the cylindrical body being configured to rotate and slide within the chamber, wherein when the cylindrical body slides and rotates within the chamber in a first direction, the door moves in a first direction, when the cylindrical body slides and rotates within the chamber in a second direction, the door moves in a second direction.

8. The door mechanism of claim 7, wherein when the door moves in the first direction, the door opens an entrance to the vehicle, when the door moves in the second direction, the door closes the entrance to the vehicle.

9. The door mechanism of claim 7, further comprising a biasing device, the biasing device comprising a first end and a second end, the first end of the biasing device being configured to be attached to the door, the second end of the biasing device being configured to be attached to the vehicle, wherein when the door moves in the first direction, the biasing the device causes the door to move from a horizontal position to a vertical position.

10. The door mechanism of claim 7, wherein the chamber comprises a plurality of recess and the cylindrical body comprises a pin traversing through the cylindrical body, the pin comprising a first end and a second end, the first end and the second end of the pin being configured to move individually within a corresponding recess of the chamber when the chamber goes from the first direction to the second direction.

11. The door mechanism of claim 10, wherein the plurality of recess are elongated.

12. The door mechanism of claim 10, wherein the plurality of recess are positioned opposite each other.

13. The door mechanism of claim 10, wherein each of the plurality of recesses is positioned diagonally on the chamber.

14. The door mechanism of claim 7 wherein the cylindrical body comprises a rotational axis, the door mechanism further comprising a door guide, the door guide being positioned off of the rotational axis, the door guide being configured to cause the door to move in a third direction.

15. The door mechanism of claim 7 further comprising a striker bolt attached to the door, a door latch attached to the vehicle, and a latch actuator attached to the door latch, wherein the latch actuator may be activated wirelessly.

16. A door mechanism comprising:
(A) a means for biasing a vehicle door to move vertically;
(B) a control means for controllably moving the door, the control means being attached to the vehicle door; and
(C) a mounting means for mounting the control means to a vehicle, wherein the control means is configured to slide and rotate in a first direction to move the vehicle door in a first direction, the control means also being configured to slide and rotate in a second direction to move the vehicle door in a second direction.

17. The door mechanism of claim 16, wherein the control means moves within a rotational axis, further comprising a guide means for guiding the door, the guide means being positioned outside the rotational axis, the guide means being configured to cause the door to move to a third direction.

18. The door mechanism of claim 16, wherein the door comprises a first end and a second end, the door mechanism further comprising a means for securing both ends of the door to the vehicle.

19. The door mechanism of claim 18, further comprising a means for actuating the securing means.

20. The door mechanism of claim 18, wherein the means for actuating the securing means can be operated wirelessly.
